(19) United States
(12) Patent Application Publication
(10) Pub. No.: US 2013/0109795 A1
(43) Pub. Date: May 2, 2013

(54) FLUOROELASTOMER COMPOSITES HAVING MODIFIED MELT RHEOLOGY

(71) Applicant: KOSTANTINOS KOURTAKIS, Media, PA (US)

(72) Inventor: KOSTANTINOS KOURTAKIS, Media, PA (US)

(73) Assignee: E. I. DU PONT DE NEMOURS AND COMPANY, Wilmington, DE (US)

(21) Appl. No.: 13/283,686

(22) Filed: Oct. 28, 2011

(51) Int. Cl. C08K 13/02; C08L 27/16; C08L 29/10; C08K 5/5419; C08L 27/18; B82Y 30/00

(52) U.S. Cl. 524/263; 977/779

(57) ABSTRACT

Fluoroelastomer compositions containing nanoparticles and a fluoroalkyl functionalized carbon black have a lower complex viscosity than do similar compounds absent the nanoparticles or containing carbon black that has been functionalized with a coupling agent other than a fluoroalkyl silane.

### FIELD OF THE INVENTION

This invention pertains to fluoroelastomer composite compositions comprising fluoroelastomer, nanoparticles and carbon black wherein the carbon black is functionalized with a fluoroalkyl silane coupling agent.

### BACKGROUND OF THE INVENTION

Fluoroelastomers are well known in the art; see for example U.S. Pat. Nos. 4,214,060; 4,281,092; 5,789,489; 6,512,063 and 6,924,344 B2. They may be partially fluorinated (i.e. contain copolymerized units of at least one monomer having C—H bonds such as vinylidene fluoride, ethylene or propylene) or be perfluorinated (i.e. contain copolymerized units of monomers not having C—H bonds). Examples of fluoroelastomers include, but are not limited to copolymers of i) vinylidene fluoride, hexafluoropropylene and, optionally, tetrafluoroethylene; ii) vinylidene fluoride, perfluoro(methyl vinyl ether) and, optionally, tetrafluoroethylene; iii) tetrafluoroethylene and propylene; and iv) tetrafluoroethylene and perfluoro(methyl vinyl ether). Optionally, the fluoroelastomer may further comprise copolymerized units of a cure site monomer to assist in the crosslinking of the elastomer.

Shaped fluoroelastomer articles (e.g. seals, gaskets, tubing, etc.) are typically made by first compounding the fluoroelastomer with other ingredients such as carbon black, curative, process aids, colorants, etc., shaping the compound (e.g. by extrusion though a die or by molding) and then curing the shaped article. If the viscosity (e.g. complex viscosity or Mooney viscosity) of the fluoroelastomer is too high, it may be difficult or impossible to compound the fluoroelastomer with other ingredients and to shape the resulting compound into the desired article. The introduction of nanoparticle fillers into a fluoroelastomer compound can reduce the viscosity of the compound. However, when carbon black is included in the compound, any viscosity reduction due to the nanoparticle filler is typically negated. It would be desirable to have carbon black filled fluoroelastomer compositions that have a reduced viscosity in order to improve the compounding and shaping processes.

### SUMMARY OF THE INVENTION

One aspect of the present invention is a composition comprising:
A) fluoroelastomer;
B) 0.0005 to 1 parts by weight, per hundred parts by weight fluoroelastomer, of nanoparticles; and
C) 5 to 100 parts by weight, per hundred parts by weight fluoroelastomer, of fluoroalkyl modified carbon black, said carbon black having on its surface at least 0.1 atomic percent oxygen per m² per gram.

### DETAILED DESCRIPTION OF THE INVENTION

The present invention is directed to compositions of fluoroelastomer, nanoparticles and fluoroalkyl modified carbon black. These compositions have a lower complex viscosity than do comparative compositions absent the nanoparticles.

The fluoroelastomer employed in the compositions may be partially fluorinated or perfluorinated. Fluoroelastomers preferably contain between 25 and 70 weight percent, based on the total weight of the fluoroelastomer, of copolymerized units of a first monomer which may be vinylidene fluoride (VF₂) or tetrafluoroethylene (TFE). The remaining units in the fluoroelastomers are comprised of one or more additional copolymerized monomers, different from said first monomer, selected from the group consisting of fluoromonomers, hydrocarbon olefins and mixtures thereof. Fluoromonomers include fluorine-containing olefins and fluorine-containing vinyl ethers.

Fluorine-containing olefins which may be employed to make fluoroelastomers by the present invention include, but are not limited to vinylidene fluoride (VF₂), hexafluoropropylene (HFP), tetrafluoroethylene (TFE), 1,2,3,3,3-pentafluoropropene (1-HPFP), 1,1,3,3,3-pentafluoropropene (2-HPFP), chlorotrifluoroethylene (CTFE) and vinyl fluoride.

Fluorine-containing vinyl ethers that may be employed to make fluoroelastomers by the present invention include, but are not limited to perfluoro(alkyl vinyl) ethers. Perfluoro(alkyl vinyl) ethers (PAVE) suitable for use as monomers include those of the formula

CF₂═CFO(R_{f′}O)ₙ(R_{f″}O)ₘR_{f} (I)

where R_{f′} and R_{f″} are different linear or branched perfluoroalkylene groups of 2-6 carbon atoms, m and n are independently 0-10, and R_{f} is a perfluoroalkyl group of 1-6 carbon atoms.

A preferred class of perfluoro(alkyl vinyl) ethers includes compositions of the formula

CF₂═CFO(CF₂CFXO)ₙR_{f} (II)

where X is F or CF₃, n is 0-5, and R_{f} is a perfluoroalkyl group of 1-6 carbon atoms.

A most preferred class of perfluoro(alkyl vinyl) ethers includes those ethers wherein n is 0 or 1 and R_{f} contains 1-3 carbon atoms. Examples of such perfluorinated ethers include perfluoro(methyl vinyl ether) (PMVE), perfluoro(ethyl vinyl ether) (PEVE) and perfluoro(propyl vinyl ether) (PPVE). Other useful monomers include compounds of the formula

CF₂═CFO[(CF₂)ₘCF₂CFZO]ₙR_{f} (III)

where R_{f} is a perfluoroalkyl group having 1-6 carbon atoms, m=0 or 1, n=0-5, and Z=F or CF₃. Preferred members of this class are those in which R_{f} is C₃F₇, m=0, and n=1.

Additional perfluoro(alkyl vinyl) ether monomers include compounds of the formula

CF₂═CFO[(CF₂CF{CF₃}O)ₙ(CF₂CF₂CF₂O)ₘ(CF₂)ₚ]CₓF₂ₓ₊₁ (IV)

where m and n independently=0-10, p=0-3, and x=1-5. Preferred members of this class include compounds where n=0-1, m=0-1, and x=1.

Other examples of useful perfluoro(alkyl vinyl ethers) include

CF₂═CFOCF₂CF(CF₃)O(CF₂O)ₘCₙF₂ₙ₊₁ (V)

where n=1-5, m=1-3, and where, preferably, n=1.

If copolymerized units of PAVE are present in fluoroelastomers employed in the composition of the invention, the PAVE content generally ranges from 25 to 75 weight percent, based on the total weight of the fluoroelastomer. If perfluoro(methyl vinyl ether) is used, then the fluoroelastomer preferably contains between 30 and 65 wt. % copolymerized PMVE units.

Hydrocarbon olefins useful in the fluoroelastomers employed in the composition of this invention include, but are not limited to ethylene and propylene. If copolymerized units of a hydrocarbon olefin are present in the fluoroelastomers, hydrocarbon olefin content is generally 4 to 30 weight percent.

The fluoroelastomers employed in the composition of the present invention may also, optionally, comprise units of one or more cure site monomers. Examples of suitable cure site monomers include, but are not limited to: i) bromine-containing olefins; ii) iodine-containing olefins; iii) bromine-containing vinyl ethers; iv) iodine-containing vinyl ethers; v) fluorine-containing olefins having a nitrile group; vi) fluorine-containing vinyl ethers having a nitrile group; vii) 1,1,3,3,3-pentafluoropropene (2-HPFP); viii) perfluoro(2-phenoxypropyl vinyl) ether; and ix) non-conjugated dienes.

Units of cure site monomer, when present in the fluoroelastomers employed in this invention, are typically present at a level of 0.05-10 wt. % (based on the total weight of fluoroelastomer), preferably 0.05-5 wt. % and most preferably between 0.05 and 3 wt. %.

The compositions of the invention contain nanoparticles at a level between 0.0005 to 1 (preferably 0.001 to 0.02) parts by weight, per hundred parts by weight fluoroelastomer. By “nanoparticles” is meant particles having a mean diameter of 5-100 nm. Suitable nanoparticles include, but are not limited inorganic oxides, such as, but not limited to titanium oxide (TiO₂), aluminum oxide (Al₂O₃), silicon oxide or silica (SiO₂), antimony oxide (Sb₂O₃), and zirconium oxide (ZrO₂). Core shell nanoparticle structures and mixtures of nanoparticles can be used. Carbides (e.g. Fe₃C) and metal nitride nanoparticles can be used. Nanosilicon oxide particles are preferred.

Compositions of the invention further contain carbon black at a level between 5 and 100 (preferably 5 to 30) parts by weight, per hundred parts by weight fluoroelastomer. The surface of the carbon black that is employed in this invention should have a surface oxygen content, as determined by ESCA, of at least 0.1 atomic % oxygen per m² per gram surface area. Such carbon blacks include MT (N990), Timcal SLP30, SLP50 and SFG15. MT (N990) is preferred.

The surface of the carbon black is fluoroalkyl modified, meaning that the surface is functionalized by reaction of a fluoroalkyl coupling agent such as a fluoroalkyl silane. Typical fluoroalkyl silanes have the general formula (I) ROSi(R¹)(R²)(R³); (II) (RO)(R′O)Si(R¹)(R²) or (III) (RO)(R′O)(R″O)SiR¹, or their mixture; wherein RO, R′O and R″O are independently C₁-C₂₀ (preferably C₁-C₄) alkoxy, C₆-C₂₀ (preferably C₆-C₁₀) aryloxy, or halogen; R¹, R² and R³ are independently selected from C₁-C₃₀ fluoroalkyl groups. A preferred fluoroalkyl silane is (tridecafluoro-1,1,2,2-tetrahydro)octyl triethoxysilane.

Fluoroaryl silanes and aryl silanes are not effective at functionalizing the carbon in a way that would allow melt viscosity improvements when nanosilicon oxide is added to the fluoroelastomer formulation. Fluoroalkyl silanes are therefore preferred. While not being bound to any theory, it is possible that the aryl silanes or fluoroaryl silanes can interact with the nanosilicon oxide through the aromatic group (and its polarizable pi electrons) with polar silanols on the nanosilicon oxide. This interaction could allow for some undesirable adsorption of the nanosilicon oxide onto the carbon surface.

Carbon black can be functionalized by any method known in the art. While not being bound to any theory, it is possible that fluoroalkyl silane is effectively coupling to the carbon surface when some oxygen (in the form of a hydroxyl, carboxyl or other species) is present on the carbon surface. It is postulated that alkoxide groups on the silane can react with the surface oxygen groups on the carbon, covalently bonding to the carbon surface.

In a typical process, carbon black is contacted with the fluoroalkyl silane or a solution of the fluoroalkyl silane diluted with a solvent such as anhydrous alcohol. A typical preparation involves heating the carbon black powder with the fluoroalkyl silane at 90° C. for 2 hours. The powder is typically washed with anhydrous alcohol to remove unreacted silane and allowed to dry.

The reaction requirements will vary with the type of carbon that is used. Temperature and time can be important variables to achieve reaction with the available surface functional groups on the carbon and the fluoroalkyl silane. Longer reaction times (>2 hours) are generally preferred at elevated temperatures (50° C. or greater). Temperatures equivalent to the reflux temperature of the solvent can be used. Reactions at room temperature may require at least 24 hours or longer to functionalize the carbon.

The carbon can be pre-treated with an oxidizing agent (e.g. HNO₃) to increase the concentration of hydroxyl groups, carboxylic acid groups, or other groups which may be reactive with the fluoroalkyl silane. The fluoroalkyl silane may also be prehydrolyzed with water and, optionally, an acid catalyst such as acetic acid prior to contacting it with the substrate carbon black.

Compositions of the invention are manufactured by combining an aqueous emulsion of fluoroelastomer with nanoparticles and functionalized carbon black. The resulting mixture is then freeze dried to remove the solvent and entrap the fluoroelastomer with the nanoparticles and carbon. Other procedures can be used to uniformly mix the nanoparticles with the fluoroelastomer. Other ingredients such as fillers, process aids, curatives, etc. may be combined with the compositions of the invention by conventional rubber mixing equipment, e.g. rubber mills, internal mixers, etc.

The fluoroelastomer compositions of this invention are useful in many industrial applications including seals, wire coatings, tubing and laminates.

### EXAMPLES

### Test Methods

Complex viscosity was measured in accordance with ASTM D 6204 using an Alpha Technologies APA 2000 controlled-strain rheometer equipped with 40 mm diameter parallel plates. Prior to testing, each 2.5 g sample was pressed into 40 mm diameter discs. The linear viscoelastic properties were measured at 80° C. using a strain of 5%. Testing was performed on duplicate samples and the average complex viscosity reported.

Atomic percent oxygen on the surface of carbon black was determined by Electron Spectroscopy for Chemical Analysis (ESCA) using an Ulvac-PHI Quantera spectrometer with a Quantera microprobe, 100 u 100 W 18 kV monochromatic Al x-ray high resolution detail spectral acquisition, 55 eV pass energy with a 0.2 eV step size.

Atomic percent oxygen per surface area carbon black was determined by dividing the atomic percent oxygen by the N₂/BET surface area (m²/g) reported by the carbon black manufacturer.

The invention is further illustrated by, but is not limited to, the following examples.

The fluoroelastomer employed in the examples was a copolymer of 68.2 mole percent units of TFE, 31.0 mole percent units of PMVE and 0.80 mole percent units of perfluoro(8-cyano-5-methyl-3,6-dioxa-1-octene) and was prepared according to the general process described in U.S. Pat. No. 5,789,489.

### Example 1

25 grams of carbon (MT black, N990, Cancarb Ltd., 0.3 atomic % oxygen per m² per g) was combined with 225 grams of absolute ethanol and placed in a 4″ diameter jar mill with zirconium oxide milling media (10 mm). The carbon slurry was milled at 80 rpm for 24 hours to create a 10 wt % slurry containing the carbon black.

4.54 g of (tridecafluoro-1,1,2,2 tetrahydro)octyl triethoxysilane (Gelest, SIT8175.0) was added to 50 grams of the slurry containing the jar milled carbon black powder. The mixture was heated to 90° C. for approximately 2 hours. Following the heating procedure, the material was filtered and subsequently washed twice with absolute ethanol and dried at room temperature. The powder was additionally dried in a vacuum oven at 90° C. for about 8 hours.

31.07 grams of fluoroelastomer emulsion (26.83 wt % in water) was combined with 2.5 grams of the silane treated carbon and 0.0364 grams of nanosilicon oxide colloid (30 wt % in isopropyl alcohol, Nissan Chemicals). The entire mixture was stirred for approximately 20 minutes and subsequently placed in a shallow pan. Liquid nitrogen was directly added to the slurry to rapidly freeze the material. The frozen solid was placed in a freeze dryer (Virtis) and evacuated to approximately 100-200 millitorr vacuum. The material was held under vacuum (while frozen) for approximately 7 days. Following the procedure the powder/cake appeared to be visually dry, but it was further dried at 70° C. in a vacuum oven for approximately 18 hours to remove any residual moisture or solvent. The dried powder was then placed in a furnace which had been preheated to 200° C. and was soaked at that temperature for 20 minutes to decompose any residual surfactants which were originally present in the fluoroelastomer emulsion. The material was removed from the furnace and quenched in air at 25° C. (allowed to rapidly cool in ambient air). Complex viscosity, measured at a frequency of 0.5 rads/s, was 3.0 MPa-s.

### Comparative Example 1

A comparative fluoroelastomer composition was made by the same procedure as Example 1 except that nanosilicon oxide was omitted. Complex viscosity, measured at a frequency of 0.5 rads/s, was 4.2 MPa-s.

### Comparative Example 2

25 grams of carbon (MT black, N990, Cancarb) was combined with 225 grams of absolute ethanol and placed in a 4″ diameter jar mill with zirconium oxide milling media (8 mm). The carbon slurry was milled at 80 rpm for 24 hours to create a 10 wt % slurry.

2.5 grams of pentafluorophenyltriethoxysilane (Gelest, SIP6716.7) was added to 42.6 grams of the slurry containing the carbon black powder. The mixture was heated to 90° C. for approximately 2 hours. Following the heating procedure, the material was filtered and subsequently washed twice with absolute ethanol and dried at room temperature. The powder was dried in a vacuum oven at 90° C. for about 8 hours to further dry the material.

31.07 grams of fluoroelastomer emulsion (26.83 wt % in water) was combined with 2.5 grams of the silane treated carbon and 0.0364 grams of nanosilicon oxide colloid (30 wt % in isopropyl alcohol, Nissan Chemicals). The entire mixture was stirred for approximately 20 minutes and subsequently placed in a shallow pan. Liquid nitrogen was directly added to the slurry to rapidly freeze the material. The frozen solid was placed in a freeze dryer (Virtis) and evacuated to approximately 100-200 millitorr vacuum. The material was held under vacuum (while frozen) for a period of approximately 7 days. Following the procedure the powder/cake appeared to be visually dry, but it was further dried at 70° C. in a vacuum oven for approximately 18 hours to remove any residual moisture or solvent. The dried powder was then placed in a furnace which had been preheated to 200° C. and was soaked at that temperature for 20 minutes to decompose any residual surfactants which were originally present in the fluoroelastomer emulsion. The material was removed from the furnace and quenched in air at 25° C. (allowed to rapidly cool in ambient air). Complex viscosity, measured at a frequency of 0.5 rads/s, was 3.3 MPa-s.

### Comparative Example 3

A comparative fluoroelastomer composition was made by the same procedure as Comparative Example 2 except that nanosilicon oxide was omitted. Complex viscosity, measured at a frequency of 0.5 rads/s, was 2.6 MPa-s.

### Comparative Example 4

25 grams of carbon (MT black, N990, Cancarb) was combined with 225 grams of absolute ethanol and placed in a 4″ diameter jar mill with zirconium oxide milling media (8 mm). The carbon slurry was milled at 80 rpm for 24 hours to create a 10 wt % slurry.

1.76 grams of phenyltrimethoxysilane (Aldrich, 43561) was added to 50 grams of the slurry containing the carbon black powder (MT black, N990, Cancarb). The mixture was heated to 90° C. for approximately 2 hours. Following the heating procedure, the material was filtered and subsequently washed twice with absolute ethanol and dried at room temperature. The powder was dried in a vacuum oven at 90° C. for about 8 hours to further dry the material.

31.07 grams of a fluoroelastomer emulsion (26.83 wt % in water) was combined with 2.5 grams of the silane treated carbon and 0.0364 grams of nanosilicon oxide colloid (30 wt % in isopropyl alcohol, Nissan Chemicals). The entire mixture was stirred for approximately 20 minutes and subsequently placed in a shallow pan. Liquid nitrogen was directly added to the slurry to rapidly freeze the material. The frozen solid was placed in a freeze dryer (Virtis) and evacuated to approximately 100-200 millitorr vacuum. The material was held under vacuum (while frozen) for a period of approximately 7 days. Following the procedure the powder/cake appeared to be visually dry, but it was further dried at 70° C. in a vacuum oven for approximately 18 hours to remove any residual moisture or solvent. The dried powder was then placed in a furnace which had been preheated to 200° C. and was soaked at that temperature for 20 minutes to decompose any residual surfactants which were originally present in the fluoroelastomer emulsion. The material was removed from the furnace and quenched in air at 25° C. (allowed to rapidly cool in ambient air). Complex viscosity, measured at a frequency of 0.5 rads/s, was 4.0 MPa-s.

### Comparative Example 5

A comparative fluoroelastomer composition was made by the same procedure as Comparative Example 4 except that nanosilicon oxide was omitted. Complex viscosity, measured at a frequency of 0.5 rads/s, was 3.2 MPa-s.

### Comparative Example 6

25 grams of carbon (Ensaco 250, Timcal, 0.02 atomic % oxygen per m² per g) was combined with 225 grams of absolute ethanol and placed in a 4″ diameter jar mill with zirconium oxide milling media (8 mm). The carbon slurry was milled at 80 rpm for 24 hours to create a 10 wt % slurry.

4.54 g of (tridecafluoro-1,1,2,2 tetrahydro)octyl triethoxysilane (Gelest, SIT8175.0) was added to 50 grams of the slurry containing the carbon black powder (Ensaco 250). The mixture was heated to 90° C. for approximately 2 hours. Following the heating procedure, the material was filtered and subsequently washed twice with absolute ethanol and dried at room temperature. The powder was dried in a vacuum oven at 90° C. for about 8 hours to further dry the material.

31.07 grams of fluoroelastomer emulsion (26.83 wt % in water) was combined with 2.5 grams of the silane treated carbon and 0.0364 grams of nanosilicon oxide colloid (30 wt % in isopropyl alcohol, Nissan Chemicals). The entire mixture was stirred for approximately 20 minutes and subsequently placed in a shallow pan. Liquid nitrogen was directly added to the slurry to rapidly freeze the material. The frozen solid was placed in a freeze dryer (Virtis) and evacuated to approximately 100-200 millitorr vacuum. The material was held under vacuum (while frozen) for approximately 7 days. Following this procedure the powder/cake appeared to be visually dry, but it was further dried at 70° C. in a vacuum oven for approximately 18 hours to remove any residual moisture or solvent. The dried powder was then placed in a furnace which had been preheated to 200° C. and was soaked at that temperature for 20 minutes to decompose any residual surfactants which were originally present in the fluoroelastomer emulsion. The material was removed from the furnace and quenched in air at 25° C. (allowed to rapidly cool in ambient air). Complex viscosity, measured at a frequency of 0.5 rads/s, was 7.8 MPa-s.

### Comparative Example 7

A comparative fluoroelastomer composition was made by the same procedure as Comparative Example 6 except that nanosilicon oxide was omitted. Complex viscosity, measured at a frequency of 0.5 rads/s, was 7.3 MPa-s.

What is claimed is:

1. A composition comprising:
A) fluoroelastomer;
B) 0.0005 to 5 parts by weight, per hundred parts by weight fluoroelastomer, of nanoparticles; and
C) 5 to 100 parts by weight, per hundred parts by weight fluoroelastomer, of fluoroalkyl modified carbon black, said carbon black having on its surface at least 0.1 atomic percent oxygen per m² per gram.

2. The composition of claim 1 wherein said nanoparticles have a mean diameter of 5 to 100 nm.

3. The composition of claim 2 wherein said nanoparticles are selected from the group consisting of inorganic oxides, metal carbides and metal nitrides.

4. The composition of claim 3 wherein said nanoparticles are selected from the group consisting of titanium oxide, aluminum oxide, silicon oxide, antimony oxide, and zirconium oxide.

5. The composition of claim 4 wherein said nanoparticles are silicon oxide.

6. The composition of claim 1 wherein said fluoroalkyl silane is selected from the group consisting of silanes having the general formula (I) ROSi(R¹)(R²)(R³); (II) (RO)(R′O)Si(R¹)(R²); (III) (RO)(R′O)(R″O)SiR¹, and mixtures thereof; wherein RO, R′O and R″O are independently C₁-C₂₀ alkoxy, C₆-C₂₀ aryloxy, or halogen; R¹, R² and R³ are independently selected from C₁-C₃₀ fluoroalkyl groups.

7. The composition of claim 6 wherein said fluoroalkyl silane is (tridecafluoro-1,1,2,2-tetrahydro)octyl triethoxysilane.

8. The composition of claim 1 wherein said carbon black is N990.
